(19) United States
(12) Patent Application Publication
(10) Pub. No.: US 2025/0028679 A1
(43) Pub. Date: Jan. 23, 2025

(54) GARBAGE COLLECTION IN A LOG-STRUCTURED FILE SYSTEM

(71) Applicant: VMware, Inc., Palo Alto, CA (US)

(72) Inventors: Maxime AUSTRUY, Pully (CH); Eric KNAUFT, San Francisco, CA (US); Sriram PATIL, San Jose, CA (US); Abhay Kumar JAIN, Cupertino, CA (US); Wenguang WANG, Santa Clara, CA (US)

(21) Appl. No.: 18/356,129

(22) Filed: Jul. 20, 2023

(51) Int. Cl. G06F 16/11; G06F 3/06; G06F 16/18

(52) U.S. Cl. CPC G06F 16/122; G06F 3/0608; G06F 3/0652; G06F 3/0673; G06F 16/1805

(57) ABSTRACT

An example method of managing a log-structured file system (LFS) on a storage device includes: receiving, at storage software executing on a host, an operation that overwrites a data block, the data block included in a segment of the LFS; determining from first metadata stored on the storage device, a change in utilization of the segment from a first utilization value to a second utilization value; modifying second metadata stored on the storage device to change a relation between the segment and a first bucket to be a relation between the segment and a second bucket, the first utilization value included in a range of the first bucket and the second utilization value included in a range of the second bucket; and executing a garbage collection process for the LFS that uses the second metadata to identify for garbage collection a set of segments in the second bucket.

### BACKGROUND

In a software-defined data center (SDDC), virtual infrastructure, which includes virtual compute, storage, and networking resources, is provisioned from hardware infrastructure that includes a plurality of host computers, storage devices, and networking devices. The provisioning of the virtual infrastructure is carried out by control plane software that communicates with virtualization software (e.g., hypervisor) installed in the host computers. Applications execute in virtual computing instances supported by the virtualization software, such as virtual machines (VMs) and/or containers. Host computers and virtual computing instances utilize persistent storage, such as hard disk storage, solid state storage, and the like. The persistent storage can be organized into various logical entities, such as volumes, virtual disks, and the like, each of which can be formatted with a file system.

A log-structured file system (LFS) is an append-only data structure. Instead of overwriting data in-place, any new write to the file system is always appended to the end of a log. An LFS is write-optimized since the software is not required to read-modify-write the data for over-writes. Due to the append-only nature of an LFS, when an operation over-writes a data block, a new version of the data block is appended to the end of the log and the prior version of that data block becomes invalid. The software does not immediately delete invalid data blocks that have been overwritten. Rather, the software executes a garbage collection process that periodically locates invalid data blocks for deletion and to reclaim storage space.

In an LFS, the software stores data blocks in segments. Each segment can be a fixed size and can store multiple data blocks. A simple garbage collection process for an LFS requires iterating through all data segments to find the most efficient data segment to reclaim. This technique is expensive in terms of central processing unit (CPU) and input/output (IO) resources as the software is required to iterate through on-disk metadata. A more efficient and less resource intensive garbage collection process for an LFS is desirable.

### SUMMARY

In an embodiment, a method of managing a log-structured file system (LFS) on a storage device is described. The method includes receiving, at storage software executing on a host, an operation that overwrites a data block, the data block included in a segment of the LFS. The method includes determining, by the storage software in response to the operation, from first metadata stored on the storage device, a change in utilization of the segment from a first utilization value to a second utilization value. The method includes modifying, by the storage software, second metadata stored on the storage device to change a relation between the segment and a first bucket to be a relation between the segment and a second bucket, the first utilization value included in a range of the first bucket and the second utilization value included in a range of the second bucket. The method includes executing, by the storage software, a garbage collection process for the LFS, the garbage collection process using the second metadata to identify for garbage collection a set of segments in the second bucket, which includes the segment.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1A is a block diagram depicting a host computer system according to embodiments.

FIG. 1B is a block diagram depicting another host computer system according to embodiments.

FIG. 2 is a block diagram depicting logical operation of system software for managing a log structure filesystem (LFS) on a storage device according to embodiments.

FIG. 3 is a block diagram depicting a segment usage table entry according to embodiments.

FIG. 4 is a block diagram depicting a segment buckets data structure according to embodiments.

FIG. 5 is a flow diagram depicting a method of handling an overwrite operation according to embodiments.

FIG. 6 is a flow diagram depicting a method of garbage collection for an LFS according to embodiments.

### DETAILED DESCRIPTION

Garbage collection in a log-structured file system is described. A log-structured file system (LFS) comprises an append-only data structure. A new write to the LFS is always appended to the end of the log rather than overwriting in-place. Due to the append-only nature of the LFS, the overwritten data blocks are not deleted immediately and need to be reclaimed at some point to free-up the space. In embodiments, data blocks are written as segments in the LFS. Each segment has a fixed size and can include multiple data blocks. The LFS maintains metadata for each segment in a segment usage table (SUT) as SUT entries. Each SUT entry keeps track of how many live data blocks are present in each segment. When an overwrite occurs, the number of live blocks value for the segment having the old revision of the data is decreased to indicate that some of the blocks in that segment are no longer valid. As the overwritten blocks are still on the storage device, the storage utilization does not change on overwrite.

It is efficient to garbage-collect the segments with lower utilization. In embodiments, a garbage collector collects segments with lower utilization to free-up as much space as possible with minimum work. For a large system, keeping track of utilization of all segments would require significant memory overhead and may not be crash consistent. Moreover, a naïve mechanism of persisting all segment utilization entries would require iterating through all segments to find an optimal candidate. This would have significant input/output (IO) and computational overhead. Thus, in embodiments, the garbage collector leverages the combination of two persistent data structures to keep track of segment utilization and quickly identify a candidate segment for garbage collection: the SUT and segment buckets. The segments are classified into different buckets based on their utilization. All segments start in a free bucket by default. When a segment is newly written, the segment is placed in the highest utilization bucket. As data in the segments is invalidated by overwrites, the segments are moved into lower utilization buckets based. The different utilization buckets are defined by different utilization thresholds. This avoids the need to keep the segments always sorted by their utilization. The segments in the lower utilization buckets naturally have low utilization and are candidates for garbage collection. These and further aspects of the techniques are described below with respect to the drawings.

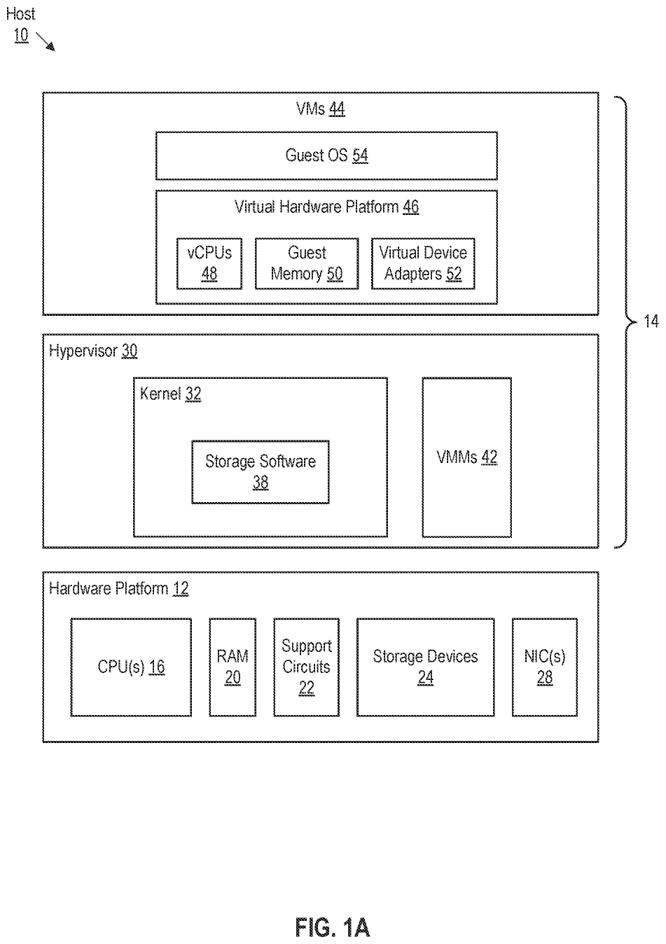

FIG. 1A is a block diagram depicting a host computer system (“host”) 10 according to embodiments. Host 10 is an example of a virtualized host. Host 10 includes software 14 executing on a hardware platform 12. Hardware platform 12 includes conventional components of a computing device, such as one or more central processing units (CPUs) 16, system memory (e.g., random access memory 20), one or more network interface controllers (NICs) 28, support circuits 22, and storage devices 24.

Each CPU 16 is configured to execute instructions, for example, executable instructions that perform one or more operations described herein, which may be stored in RAM 20. CPU(s) 16 include processors and each processor can be a core or hardware thread in a CPU 16. For example, a CPU 16 can be a microprocessor, with multiple cores and optionally multiple hardware threads for core(s), each having an x86 or ARM® architecture. The system memory is connected to a memory controller in each CPU 16 or in support circuits 22 and comprises volatile memory (e.g., RAM 20). Storage (e.g., each storage device 24) is connected to a peripheral interface in each CPU 16 or in support circuits 22. Storage is persistent (nonvolatile). As used herein, the term memory (as in system memory or RAM 20) is distinct from the term storage (as in a storage device 24).

Each NIC 28 enables host 10 to communicate with other devices through a network (not shown). Support circuits 22 include any of the various circuits that support CPUs, memory, and peripherals, such as circuitry on a mainboard to which CPUs, memory, and peripherals attach, including buses, bridges, cache, power supplies, clock circuits, data registers, and the like. Storage devices 24 include magnetic disks, SSDs, and the like as well as combinations thereof.

Software 14 comprises hypervisor 30, which provides a virtualization layer directly executing on hardware platform 12. In an embodiment, there is no intervening software, such as a host operating system (OS), between hypervisor 30 and hardware platform 12. Thus, hypervisor 30 is a Type-1 hypervisor (also known as a “bare-metal” hypervisor). Hypervisor 30 abstracts processor, memory, storage, and network resources of hardware platform 12 to provide a virtual machine execution space within which multiple virtual machines (VM) 44 may be concurrently instantiated and executed.

Hypervisor 30 includes a kernel 32 and virtual machine monitors (VMMs) 42. Kernel 32 is software that controls access to physical resources of hardware platform 12 among VMs 44 and processes of hypervisor 30. Kernel 32 includes storage software 38. Storage software 38 includes one or more layers of software for handling storage input/output (IO) requests from hypervisor 30 and/or guest software in VMs 44 to storage devices 24. A VMM 42 implements virtualization of the instruction set architecture (ISA) of CPU(s) 16, as well as other hardware devices made available to VMs 44. A VMM 42 is a process controlled by kernel 32.

A VM 44 includes guest software comprising a guest OS 54. Guest OS 54 executes on a virtual hardware platform 46 provided by one or more VMMs 42. Guest OS 54 can be any commodity operating system known in the art. Virtual hardware platform 46 includes virtual CPUs (vCPUs) 48, guest memory 50, and virtual device adapters 52. Each vCPU 48 can be a VMM thread. A VMM 42 maintains page tables that map guest memory 50 (sometimes referred to as guest physical memory) to host memory (sometimes referred to as host physical memory). Virtual device adapters 52 can include a virtual storage adapter for accessing storage.

FIG. 1B is a block diagram depicting a host 100 according to embodiments. Host 100 is an example of a non-virtualized host. Host 100 comprises a host OS 102 executing on a hardware platform. The hardware platform in FIG. 1B is identical to hardware platform 12 and thus designated with identical reference numerals. Host OS 102 can be any commodity operating system known in the art Host OS 102 includes functionality of kernel 32 as shown in FIG. 1A, including storage software 38. Host OS 102 manages processes 104, rather than virtual machines. The garbage collection techniques described herein can be performed in a virtualized host, such as that shown in FIG. 1A, or a non-virtualized host, such as that shown in FIG. 1B.

In embodiments, storage software 38 accesses local storage devices (e.g., storage devices 24 in hardware platform 12). In other embodiments, storage software 38 accesses storage that is remote from hardware platform 12 (e.g., shared storage accessible over a network through NICs 28, host bus adaptors, or the like). Shared storage can include one or more storage arrays, such as a storage area network (SAN), network attached storage (NAS), or the like. Shared storage may comprise magnetic disks, solid-state disks, flash memory, and the like as well as combinations thereof. In some embodiments, local storage of a host (e.g., storage devices 24) can be aggregated with local storage of other host(s) and provisioned as part of a virtual SAN, which is another form of shared storage. The garbage collection techniques described herein can be utilized with log-structure file systems maintained on local storage devices and/or shared storage.

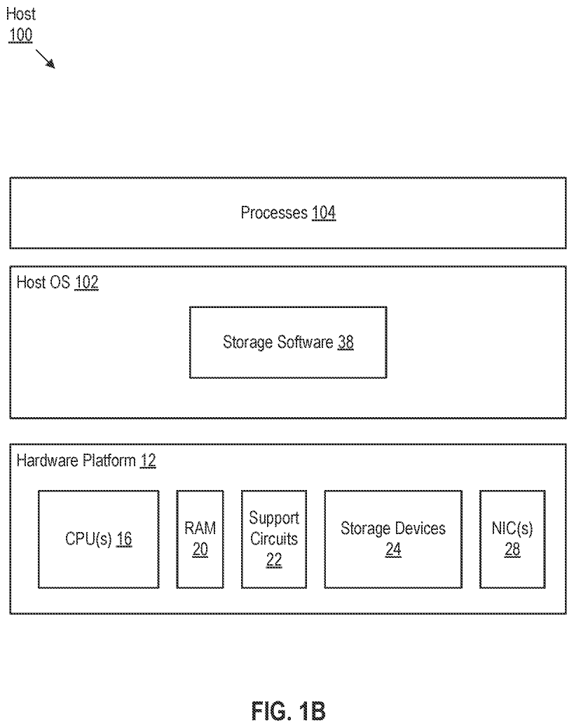

FIG. 2 is a block diagram depicting logical operation of system software for managing a log structure filesystem (LFS) on a storage device according to embodiments. FIG. 2 shows components of system software 202 in cooperation with components of hardware platform 12. System software 202 can be hypervisor 30 in a virtualized host or host OS 102 in a non-virtualized host. Hardware platform 12 includes CPUs 16, a storage device 24, and RAM 20, as shown in FIGS. 1A-1B. CPUs 16 are connected to RAM 20 through a bus or interconnect (part of support circuits 22). System software 202 includes storage software 38. VMMs 42 or processes 104 submit IO requests to storage software 38 depending on whether system software 202 is hypervisor 30 or host OS 102. Hardware platform 12 includes a bus interface 224 connected to storage device 24. CPUs 16 and RAM 20 are coupled to bus interface 224 (e.g., via a root complex in support circuits 22). CPUs 16, through execution of system software 202, can send data to, and receive data from, storage device 24. In the embodiment, storage software 38 accesses storage device 24 that is part of hardware platform 12. In other embodiments, storage software 38 can access shared storage as discussed above. For purposes of clarity by example, an LFS and corresponding on-disk data structures are described as being on storage device 24 in hardware platform 12. Those skilled in the art will appreciate that the LFS and on-disk data structures can instead be maintained on shared storage accessible by the host.

Storage device 24 includes an LFS 226. LFS 226 includes segments 202. Each segment 202 can include zero or more data blocks 204. Each data block 204 comprises data for a file stored in LFS 226. Each segment 202 is a fixed size on storage device 24. LFS 226 comprises an append-only file system. Thus, when storage software 38 needs to modify a data block 204, the data block is not overwritten. Rather, storage software 38 creates a new version of the data block in a segment 202, which becomes the valid version of the data block. The prior version of the data block remains in its segment 202 but is now invalid. Thus, at a given time, there can be multiple versions of a data block in LFS 226, only one of which is a valid version of the data block. Storage software 38 reclaims invalid data blocks 204 to free space in LFS 226 using garbage collector 216. Garbage collector 216 performs the garbage collection process periodically.

Storage software 38 maintains metadata for LFS 226. The metadata includes segment usage table (SUT) 206 and segment buckets 210. SUT 206 includes SUT entries 208. Each SUT entry 208 is associated with a particular segment 202. In embodiments, each segment 202 includes a segment index (also referred to as a segment identifier) and SUT entries 208 are keyed by segment indexes. Each SUT entry 208 includes a segment index and a set of data for the segment. For example, SUT entries 208 can be key/value pairs, where the segment index is the key and the data set is the value. The data set for a segment can include a value (numLiveBlocks) that tracks the number of valid data blocks in the corresponding segment. When a data block is overwritten, its prior version is invalid and the value numLiveBlocks is decremented in that segment. Thus, at a given time, a segment can include multiple blocks for which only a portion thereof are valid. In such case, numLiveBlocks is less than the total number of blocks currently stored in the segment.

As overwritten data blocks are not free (until garbage collection), disk utilization does not change on overwrite operations. The utilization of a segment is calculated as follows: (1) numTotalBlocksInSegment=segmentSize/blockSize; and (2) segmentUtilization=numLiveBlocks/numTotalBlocksInSegment. In the equations, “blockSize” is the size of each data block 204 (e.g., in bytes, kilobytes, etc.); “segmentSize” is the size of each segment; “numTotalBlocksInSegment is the total number of data blocks that can be stored in a segment; “numLiveBlocks” is the number of valid data blocks; and “segmentUitlization” is a value indicating how much of the segment is utilized by valid data blocks.

It is efficient to garbage-collect the segments with lower utilization. For example, if garbage collector 216 collects two segments with 50% utilization and writes one new full segment, storage software 38 needs to read two segments and write one new segment. This operation results in one segment being freed (e.g., two freed minus one written). The efficiency of garbage collection can be expressed as: efficiencyOfCleaning=numSegsFreed/(numSegsRead+numSegsWritten). In the equation, “numSegsFreed” is the number of freed segments; “numSegsRead” is the number of segments read during the garbage collection operation; “numSegsWritten” is the number of segments written in the garbage collection operation; and “efficiencyOfCleaning” is the efficiency of the garbage collection operation. In the example above, this results in an efficiency of 1/(2+1)=33%. Garbage collection of lower utilized segments is more efficient than higher utilized segments. For example, garbage collecting 10% utilized segments requires numSegsRead=10, numSegsWritten=1, numSegsFreed=9. This results in an efficiency of 81%.

Based on the above calculations, garbage collector 216 is configured to collect segments with lower utilization to free up as much space as possible with minimum work. For a large file system, however, keeping track of the utilization of all segments can require significant memory overhead and may not be crash consistent (if using in-memory data structures). A mechanism of persisting all segment utilization entries to storage device 24 still requires iterating through all segments to find optimal candidates for garbage collection. Such a technique will have significant IO and computational overhead. Thus, garbage collector 216 employs a more efficient technique for identifying lower utilization segments for garbage collection, as described below.

In embodiments, garbage collector 216 utilizes SUT 206 and segment buckets 210 to keep track of segment utilization and to quickly identify candidate segments for garbage collection. SUT 206 comprises SUT entries 208 stored on storage device 24. SUT 206 can be any type of data structure. Storage software 38 cannot assume anything about the write workload distribution across segments 202 in LFS 226. Any data block 204 can be overwritten at any point in time. Storage software 38 updates the utilization of the affected segments accordingly based on overwrite operations (e.g., by modifying the value of numLiveBlocks in the segments' SUT entries 208). In embodiments, SUT entries 208 are ordered by segment index, where the segment index is the physical offset of the segment on storage device 24 divided by the segment size. An overwrite operation can determining the segment index of the data block being overwritten as follows: segmentIndex=PBA/segmentSize. In the formula, “PBA” is the physical block address of the data block, “segmentSize” is the size of the segment, and “segmentIndex” is the segment index. The overwrite operation then iterates over SUT 206 using the segment index to read and update the segment data (e.g., the numLiveBlocks value).

Segment buckets 210 comprises another on-disk data structure that is used to reduce memory overhead and allow for efficient garbage collection. Segments are classified into different segment buckets based on their utilization. By default, segments are placed into the FREE bucket. When a segment is written (assuming all data blocks are valid), the segment is placed into the HIGHEST utilization bucket. As data blocks get invalidated by overwrites, a segment can move from one segment bucket to another (e.g., from higher utilization to lower utilization). This movement is only required when the utilization crosses the threshold between segment buckets. This avoids the need to keep segments sorted by their utilization. The segments in the lower utilization buckets naturally have lower utilization and are prime candidates for garbage collection. An example configuration of segment buckets is:
LOWEST 0-25%
LOW 25-50%
MID 50-70%
HIGH 70-90%
HIGHEST 90-100%
   This is just one example and those skilled in the art will appreciate that any number of segment buckets can be used that include different ranges of utilization.

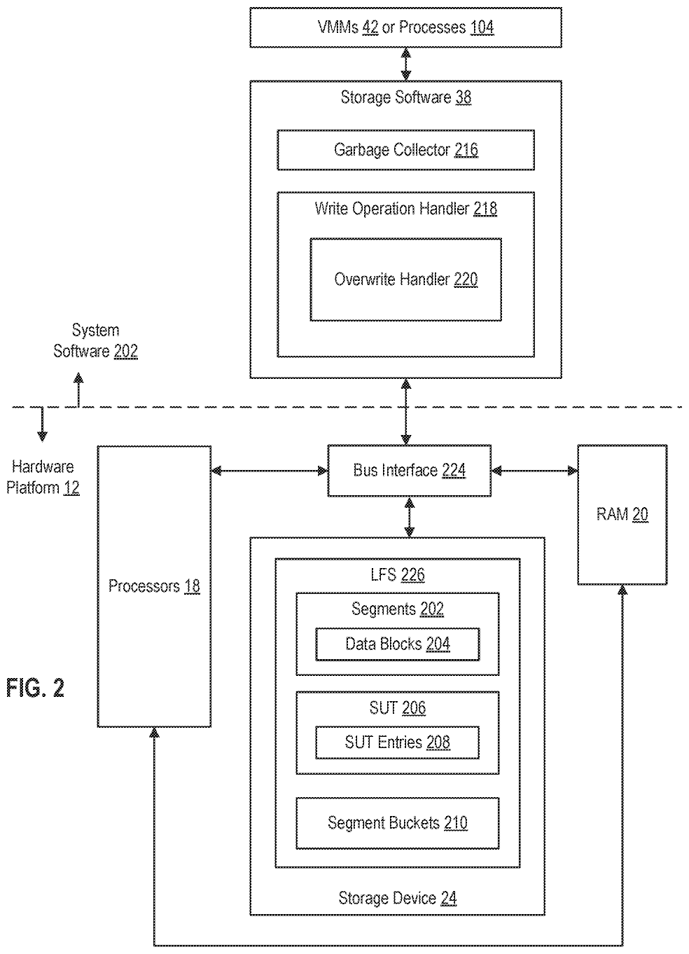

FIG. 3 is a block diagram depicting a SUT entry 208 according to embodiments. SUT entry 208 includes a segment index 302 and a data set 304. Segment index 302 identifies a segment. Data set 304 includes various data associated with a segment. Data set 304 can include numLiveBlocks 306 that tracks the number of valid blocks in the corresponding segment. Segment index 302 can be a key and data set 304 the value in a key/value pair.

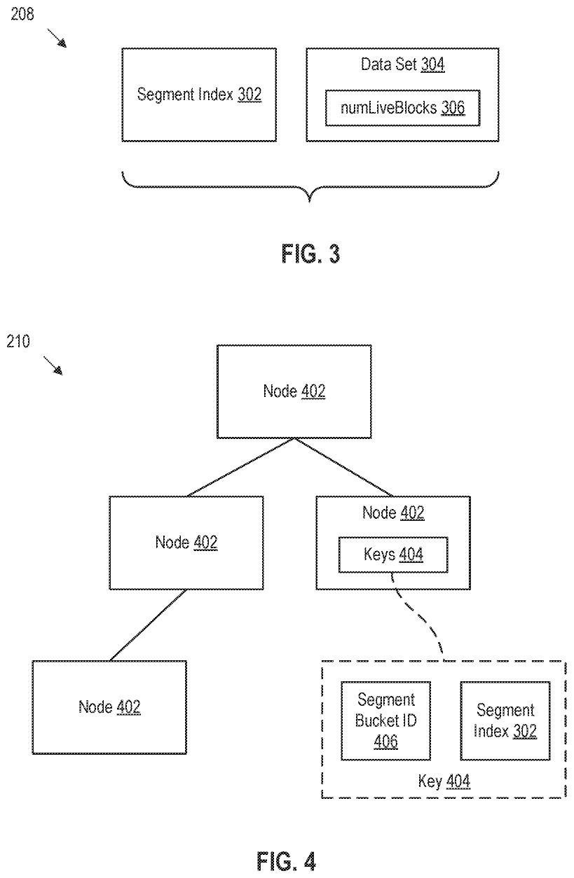

FIG. 4 is a block diagram depicting a segment buckets data structure 210 according to embodiments. In an embodiment, data structure 210 is a B-tree comprises nodes 402 having keys 404. Each key 404 comprises a segment bucket ID 406 and a segment index 302. For example, segment bucket ID 406 can be upper bits of a value and segment index 302 can be the lower bits of the value. Those skilled in the art will appreciate that other types of data structures can be used that track keys in the form of <segment bucket ID, segment index>. In the data structure, each segment bucket has an ID and segment indexes are related to segment bucket IDs of the corresponding bucket in which their utilization falls.

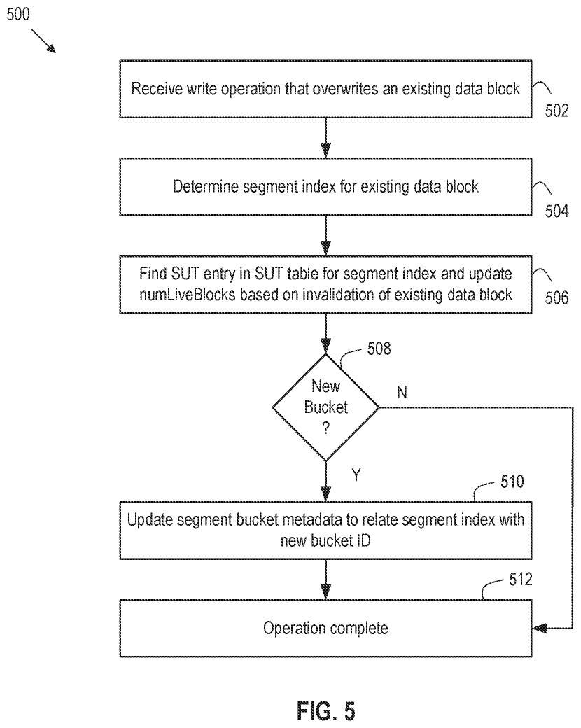

FIG. 5 is a flow diagram depicting a method 500 of handling an overwrite operation according to embodiments. Method 500 begins at step 502, where write operation handler 218 of storage software 38 receives a write operation that overwrites an existing data block in LFS 226. Write operation handler 218 invokes overwrite handler 220. At step 504, overwrite handler 218 determines a segment index for the existing data block. Overwrite handler 218 can determine the segment index based on the physical block address targeted by the write operation and the segment size using the formula discussed above. At step 506, overwrite handler 218 finds the SUT entry in the SUT table for the segment index. Overwrite handler 218 updates the numLiveBlocks value based on the invalidation of the existing data block (e.g., decrement numLiveBlocks).

At step 508, overwrite handler 218 determines if the overwrite operation causes the segment of the existing data block to have a utilization that falls into a new bucket. If not, method 500 proceeds to step 512, where overwrite handler completes its operation. Otherwise, method 500 proceeds to step 510. At step 510, overwrite handler 218 updates the segment bucket metadata to relate the segment index with the new bucket ID. Overwrite handler can determine if a new bucket is required by noting the utilization before and after the invalidation of the data block. If the utilization falls into a range outside of the bucket the segment is current in, the segment will be placed into a new bucket. Overwrite handler 218 can update the entry in the segment bucket metadata or can delete the current entry and insert a new entry with a new bucket ID for the segment.

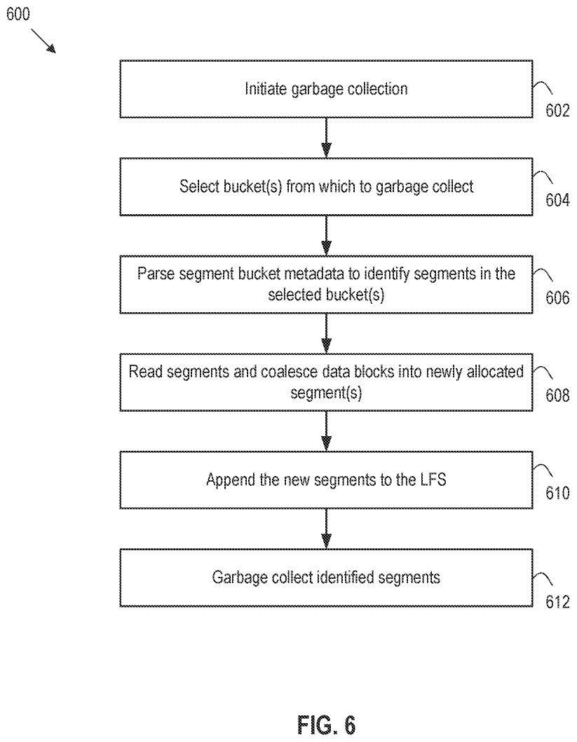

FIG. 6 is a flow diagram depicting a method 600 of garbage collection for an LFS according to embodiments. Method 600 begins at step 602, where garbage collector 216 initiates a garbage collection process. At step 604, garbage collector 216 selects bucket(s) from which to garbage collect. In embodiments, garbage collector 216 selects bucket(s) having lower utilization. Garbage collector 216 can iterate over buckets from lowest to highest utilization. Garbage collector 216 can select buckets to garbage collect until meeting some threshold amount of space to free. At step 606, garbage collector 216 parses segment bucket metadata to identify segments in the selected bucket(s). At step 608, garbage collector 216 reads the segments and coalesces the data blocks therein into newly allocated segments. At step 610, garbage collector 216 appends the new segment(s) to the LFS. At step 612, garbage collector 216 collects the identified segments (i.e., the old segments) to free space in the LFS.

Garbage collector 216 ensures that the cleaning is most efficient by making sure that all the segments with lower utilization will be cleaned before there are no more segments left in the lower segment buckets. Garbage collector 216 selects segments from segment buckets to avoid having to iterate over all SUT entries to find segments with lower utilization. This saves CPU cycles. Since garbage collector 216 scans the buckets from lowest to highest utilization, the segments will always be the most efficient to clean from the current list of segments. In embodiments, the segment bucket entries are relatively small in size, e.g., 4 bytes for the key (segment bucket ID, segment index) and 8 bytes of value (segment metadata). Thus, many entries can fit in the data structure, allowing the data structure to be resident in system memory. This reduces the IO overhead and latency when garbage collector 216 iterates over the segment buckets.

While some processes and methods having various operations have been described, one or more embodiments also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

One or more embodiments of the present invention may be implemented as one or more computer programs or as one or more computer program modules embodied in computer readable media. The terms computer readable medium or non-transitory computer readable medium refer to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Certain embodiments as described above involve a hardware abstraction layer on top of a host computer. The hardware abstraction layer allows multiple contexts to share the hardware resource. These contexts can be isolated from each other, each having at least a user application running therein. The hardware abstraction layer thus provides benefits of resource isolation and allocation among the contexts. Virtual machines may be used as an example for the contexts and hypervisors may be used as an example for the hardware abstraction layer. In general, each virtual machine includes a guest operating system in which at least one application runs. It should be noted that, unless otherwise stated, one or more of these embodiments may also apply to other examples of contexts, such as containers. Containers implement operating system-level virtualization, wherein an abstraction layer is provided on top of a kernel of an operating system on a host computer or a kernel of a guest operating system of a VM. The abstraction layer supports multiple containers each including an application and its dependencies. Each container runs as an isolated process in user-space on the underlying operating system and shares the kernel with other containers. The container relies on the kernel's functionality to make use of resource isolation (CPU, memory, block I/O, network, etc.) and separate namespaces and to completely isolate the application's view of the operating environments. By using containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Boundaries between components, operations, and data stores are somewhat arbitrary, and particular operations are illustrated in the context of specific configurations. Other allocations of functionality are envisioned and may fall within the scope of the appended claims. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of managing a log-structured file system (LFS) on a storage device, comprising:
receiving, at storage software executing on a host, an operation that overwrites a data block, the data block included in a segment of the LFS;
determining, by the storage software in response to the operation, from first metadata stored on the storage device, a change in utilization of the segment from a first utilization value to a second utilization value;
modifying, by the storage software, second metadata stored on the storage device to change a relation between the segment and a first bucket to be a relation between the segment and a second bucket, the first utilization value included in a range of the first bucket and the second utilization value included in a range of the second bucket; and
executing, by the storage software, a garbage collection process for the LFS, the garbage collection process using the second metadata to identify for garbage collection a set of segments in the second bucket, which includes the segment.

2. The method of claim 1, wherein the second utilization value included in the range of the second bucket is less than the first utilization value included in the range of the first bucket.

3. The method of claim 1, wherein the first metadata comprises a segment usage table (SUT) including an entry that relates an identifier of the segment to a set of data associated with the segment, the set of data including a number of valid data blocks in the segment.

4. The method of claim 3, wherein the operation that overwrites the data block changes the number of valid data blocks in the segment from a first value to a second value, and wherein the storage software determines the change in utilization of the segment based on the change in the number of valid data blocks from the first value to the second value.

5. The method of claim 1, wherein the second metadata comprises a plurality of buckets, including the first bucket and the second bucket, the plurality of buckets respectively associated with a plurality of utilization ranges.

6. The method of claim 5, wherein a second utilization range for the second bucket is less than a first utilization range for the first bucket.

7. The method of claim 1, further comprising:
receiving, at the storage software, another operation that overwrites another data block, the other data block included in another segment of the LFS;
determining, by the storage software in response to the other operation, from the first metadata, a change in utilization of the other segment from a first utilization value to a second utilization value;
determining, by the storage software, that the change in utilization of the other segment does not cause a change in buckets for the other segment within the second metadata; and
maintaining, by the storage software, a relation between the other data segment and its bucket without change in response to the other operation.

8. A non-transitory computer readable medium comprising instructions to be executed in a computing device to cause the computing device to carry out a method of managing a log-structured file system (LFS) on a storage device, comprising:
receiving, at storage software executing on a host, an operation that overwrites a data block, the data block included in a segment of the LFS;
determining, by the storage software in response to the operation, from first metadata stored on the storage device, a change in utilization of the segment from a first utilization value to a second utilization value;
modifying, by the storage software, second metadata stored on the storage device to change a relation between the segment and a first bucket to be a relation between the segment and a second bucket, the first utilization value included in a range of the first bucket and the second utilization value included in a range of the second bucket; and
executing, by the storage software, a garbage collection process for the LFS, the garbage collection process using the second metadata to identify for garbage collection a set of segments in the second bucket, which includes the segment.

9. The non-transitory computer readable medium of claim 8, wherein the second utilization value included in the range of the second bucket is less than the first utilization value included in the range of the first bucket.

10. The non-transitory computer readable medium of claim 8, wherein the first metadata comprises a segment usage table (SUT) including an entry that relates an identifier of the segment to a set of data associated with the segment, the set of data including a number of valid data blocks in the segment.

11. The non-transitory computer readable medium of claim 10, wherein the operation that overwrites the data block changes the number of valid data blocks in the segment from a first value to a second value, and wherein the storage software determines the change in utilization of the segment based on the change in the number of valid data blocks from the first value to the second value.

12. The non-transitory computer readable medium of claim 8, wherein the second metadata comprises a plurality of buckets, including the first bucket and the second bucket, the plurality of buckets respectively associated with a plurality of utilization ranges.

13. The non-transitory computer readable medium of claim 12, wherein a second utilization range for the second bucket is less than a first utilization range for the first bucket.

14. The non-transitory computer readable medium of claim 8, further comprising:
receiving, at the storage software, another operation that overwrites another data block, the other data block included in another segment of the LFS;
determining, by the storage software in response to the other operation, from the first metadata, a change in utilization of the other segment from a first utilization value to a second utilization value;
determining, by the storage software, that the change in utilization of the other segment does not cause a change in buckets for the other segment within the second metadata; and
maintaining, by the storage software, a relation between the other data segment and its bucket without change in response to the other operation.

15. A computer system, comprising:
a hardware platform comprising an interface to a storage device, the storage device including a log-structured file system (LFS);
system software, executing on the hardware platform, including storage software configured to:
receive an operation that overwrites a data block, the data block included in a segment of the LFS;
determine, in response to the operation, from first metadata stored on the storage device, a change in utilization of the segment from a first utilization value to a second utilization value;
modify, second metadata stored on the storage device to change a relation between the segment and a first bucket to be a relation between the segment and a second bucket, the first utilization value included in a range of the first bucket and the second utilization value included in a range of the second bucket; and
execute a garbage collection process for the LFS, the garbage collection process using the second metadata to identify for garbage collection a set of segments in the second bucket, which includes the segment.

16. The computer system of claim 15, wherein the second utilization value included in the range of the second bucket is less than the first utilization value included in the range of the first bucket.

17. The computer system of claim 15, wherein the first metadata comprises a segment usage table (SUT) including an entry that relates an identifier of the segment to a set of data associated with the segment, the set of data including a number of valid data blocks in the segment.

18. The computer system of claim 17, wherein the operation that overwrites the data block changes the number of valid data blocks in the segment from a first value to a second value, and wherein the storage software determines the change in utilization of the segment based on the change in the number of valid data blocks from the first value to the second value.

19. The computer system of claim 15, wherein the second metadata comprises a plurality of buckets, including the first bucket and the second bucket, the plurality of buckets respectively associated with a plurality of utilization ranges.

20. The computer system of claim 19, wherein a second utilization range for the second bucket is less than a first utilization range for the first bucket.
